(19) United States
(12) Patent Application Publication
(10) Pub. No.: US 2025/0222569 A1
(43) Pub. Date: Jul. 10, 2025

(54) CLEAN OUT CAP REMOVAL DEVICE

(71) Applicant: Stephen Twedt, Ocean Shores, WA (US)

(72) Inventor: Stephen Twedt, Ocean Shores, WA (US)

(21) Appl. No.: 18/409,124

(22) Filed: Jan. 10, 2024

(51) Int. Cl. B25B 13/48; B25B 13/06; B25B 13/50

(52) U.S. Cl. CPC B25B 13/481; B25B 13/06; B25B 13/50

(57) ABSTRACT

A clean out cap removal device includes a handle has a length of at least 75.0 cm which can be extended into a hole to reach a clean out cap on a buried water pipe. A first box is attached to the handle to engage a knob of a first size on the clean out cap to remove the clean out cap from the water pipe. A second box is movably positioned within the first box and the second box has dimensions less than dimensions of the first box. In this way the second box can engage a knob of a second size on the clean out cap to remove the clean out cap from the water pipe. The second box is biased into a first position having the second box is positioned to engage the knob of the second size. Conversely, the second box is urgeable into a second position when the second box abuts the knob of the first size to facilitate the first box to engage the knob of the first size.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to clean out cap devices and more particularly pertains to a new clean out cap device for removing a clean out cap from a buried water pipe. The device includes a handle that is elongated to extend into a hole and a first box attached to the handle to engage a knob of a first size on a clean out cap for removing the clean out cap from the buried water pipe. The device includes a second box that is slidably disposed within the first box to engage a knob of a second size on the clean out cap. The second cap is biased into a first position to engage the knob of the second size and the second cap is urgeable into a second position to facilitate the first box to engage the knob of the first size.

### (2) Description of Related Art Including Information Disclosed Under 37 CFR 1.97 and 1.98

The prior art relates to clean out cap devices including a variety of clean out cap removal tools that each includes an elongated handle and an engagement to engage a knob on a clean out cap and a variety of clean out cap removal tools that each includes an elongated handle and a plurality of engagements of varying sizes that are attachable to the elongated handle for removing clean out caps that have knobs of varying sizes. In no instance does the prior art disclose a clean out cap removal tool that includes and elongated handle and a first box attached to the handle for engaging a knob of a first size on a clean out cap and a second box slidably disposed on the first box for engaging a knob of a second size on the clean out cap.

### BRIEF SUMMARY OF THE INVENTION

An embodiment of the disclosure meets the needs presented above by generally comprising a handle has a length of at least 75.0 cm which can be extended into a hole to reach a clean out cap on a buried water pipe. A first box is attached to the handle to engage a knob of a first size on the clean out cap to remove the clean out cap from the water pipe. A second box is movably positioned within the first box and the second box has dimensions less than dimensions of the first box. In this way the second box can engage a knob of a second size on the clean out cap to remove the clean out cap from the water pipe. The second box is biased into a first position having the second box is positioned to engage the knob of the second size. Conversely, the second box is urgeable into a second position when the second box abuts the knob of the first size to facilitate the first box to engage the knob of the first size.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a clean out cap removal device according to an embodiment of the disclosure.

FIG. 2 is an exploded perspective view of an embodiment of the disclosure.

FIG. 3 is a perspective in-use view of an embodiment of the disclosure showing a handle being extended into a hole to access a clean out cap on a water pipe.

FIG. 4 is a perspective in-use view of an embodiment of the disclosure showing a first box being lowered onto a knob of a first size on a clean out cap.

FIG. 5 is a phantom in-use view of an embodiment of the disclosure showing a first box being positioned around a knob of a first size on a clean out cap.

FIG. 6 is a perspective in-use view of an embodiment of the disclosure showing a second box being lowered onto a knob of a second size on a clean out cap.

FIG. 7 is a phantom in-use view of an embodiment of the disclosure showing a second box being positioned around a knob of a second size on a clean out cap.

### DETAILED DESCRIPTION OF THE INVENTION

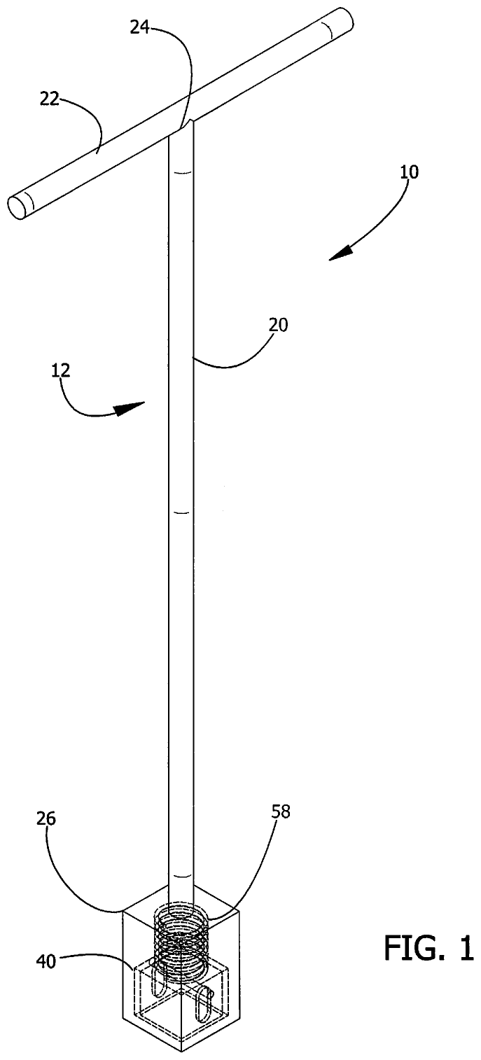

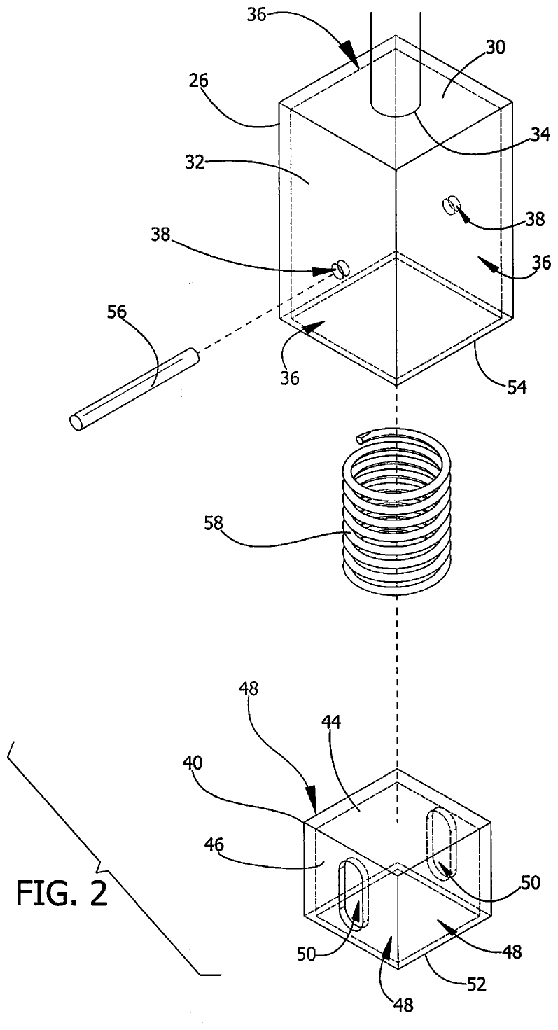

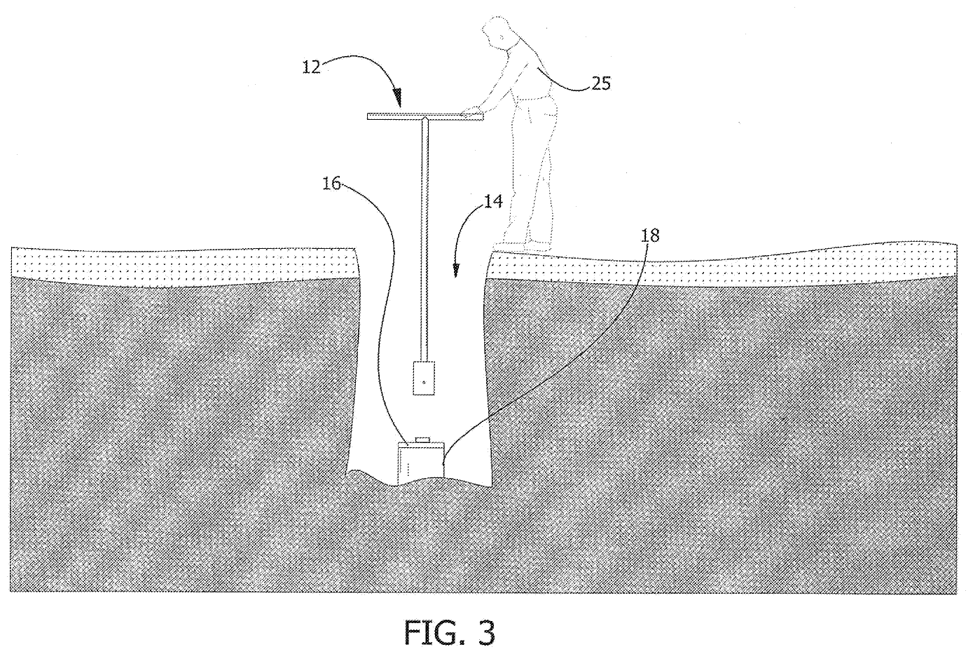

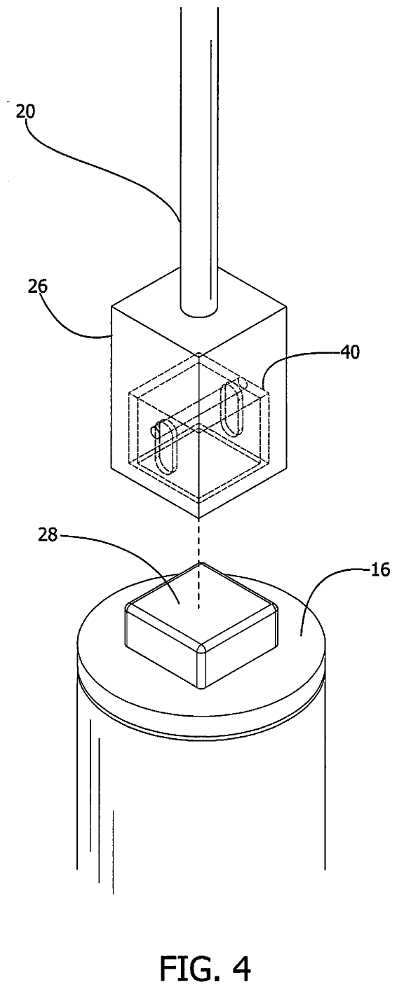

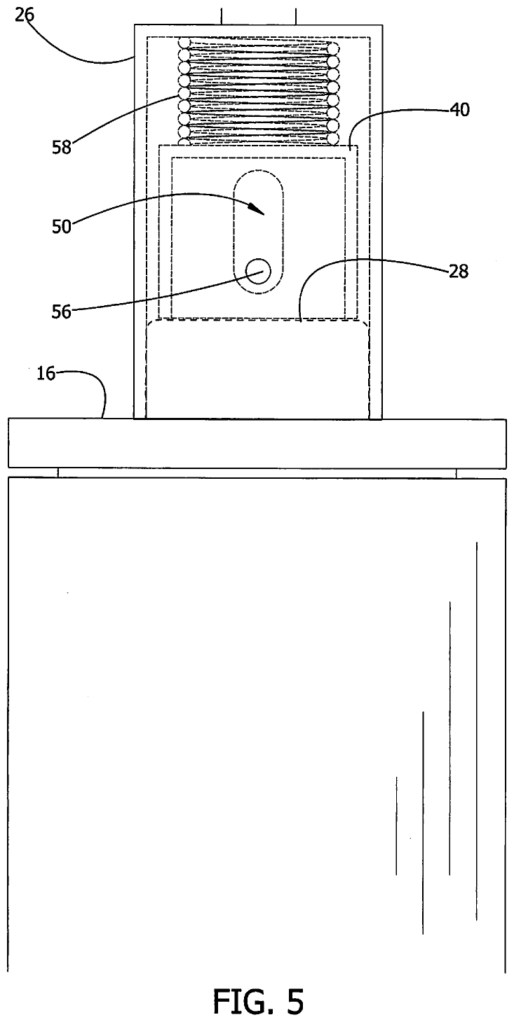

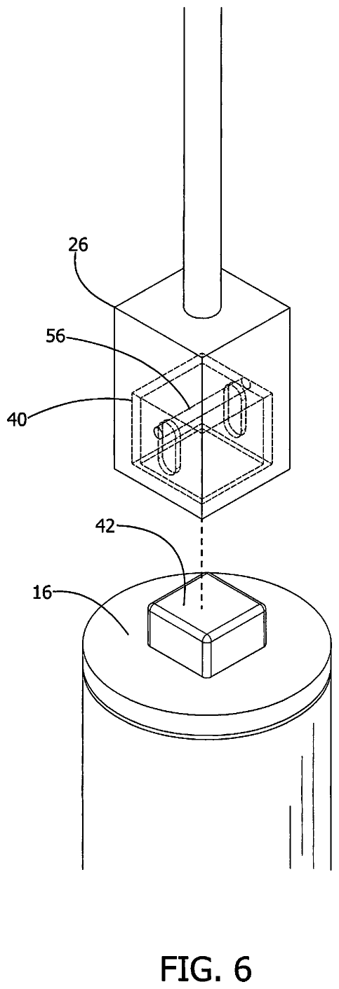

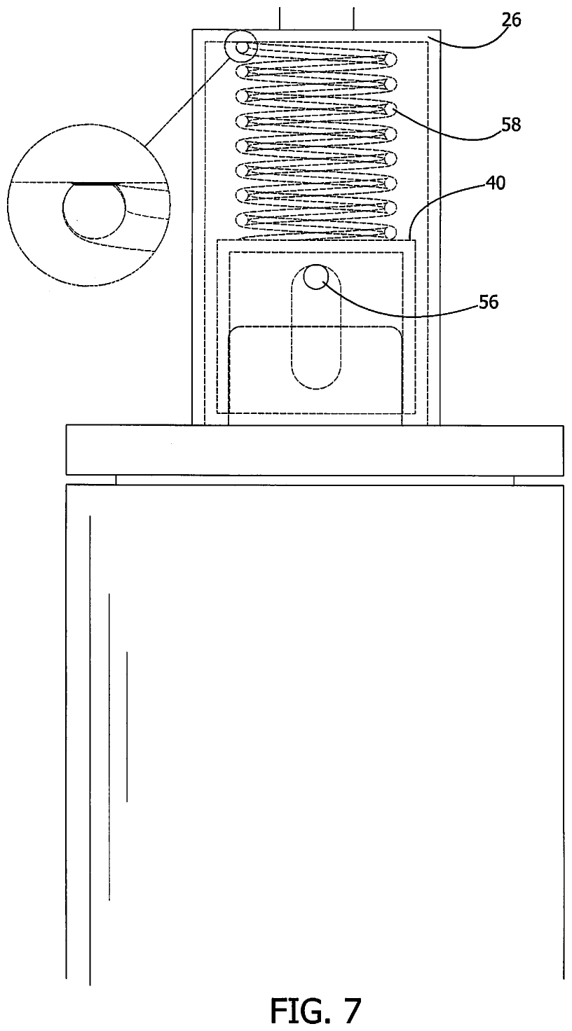

With reference now to the drawings, and in particular to FIGS. 1 through 7 thereof, a new clean out cap device embodying the principles and concepts of an embodiment of the disclosure and generally designated by the reference numeral 10 will be described.

As best illustrated in FIGS. 1 through 7, the clean out cap removal device 10 generally comprises a handle 12 has a length of at least 75.0 cm such that the handle 12 can be extended into a hole 14 to reach a clean out cap 16 on a buried water pipe 18. The handle 12 includes a shaft 20 and a grip 22 that is transversely oriented on an upper end 24 of the shaft 20; The grip 22 is gripped by a user 25 having the shaft 20 extending downwardly into the hole 14. The water pipe 18 may be a water pipe associated with a municipal water system or the like and the clean out cap 16 may be a threaded clean out cap of any conventional size that is commonly employed on water pipes.

A first box 26 is attached to the handle 12 to engage a knob of a first size 28 on the clean out cap 16 when the handle 12 is extended into the hole 14. In this way the clean out cap 16 can be removed from the water pipe 18 when the handle 12 is rotated in a first direction and to facilitate the clean out cap 16 to be installed onto the water pipe 18 when the handle 12 is rotated in a second direction. The first box 26 has a top wall 30 and an outer wall 32 extending downwardly from the top wall 30 and a bottom end 34 of the shaft 20 is attached to the top wall 30 at a point that is centrally located on the top wall 30. The outer wall 32 has a plurality of perpendicularly oriented sides 36 such that the first box 26 has a rectangular shape to conform to the shape of the knob of the first size 28 on the clean out cap 16. The first box 26 has a pair of holes 38 each extending through a respective one of the plurality of perpendicularly oriented sides 36 of the outer wall 32. Additionally, the pair of holes 38 are positioned on opposite sides of the outer wall 32 with respect to each other. The first box 26 may have a height of approximately 10.0 cm and a width of approximately 6.0 cm.

A second box 40 is movably positioned within the first box 26 and the second box 40 has dimensions that are less than dimensions of the first box 26. In this way the second box 40 can engage a knob of a second size 42 on the clean out cap 16 when the handle 12 is extended into the hole 14. Thus, the clean out cap 16 can be removed from the water pipe 18 when the handle 12 is rotated in a first direction and the clean out cap 16 can be installed onto the water pipe 18 when the handle 12 is rotated in a second direction. The second box 40 is biased into a first position having the second box 40 being positioned to engage the knob of the second size 42. Conversely, the second box 40 is urgeable into a second position when the second box 40 abuts the knob of the first size 28 to facilitate the first box 26 to engage the knob of the first size 28.

The second box 40 has an upper wall 44 and an exterior wall 46 extending downwardly from the upper wall 44. The exterior wall 46 has a plurality of perpendicularly oriented sides 48 such that the second box 40 has a rectangular shape to conform to the shape of the knob of the second size 42. The second box 40 has a pair of slots 50 each extending through the exterior wall 46 and the pair of slots 50 are positioned on opposite sides of the exterior wall 46 with respect to each other. Each of the pair of slots 50 is elongated to extend substantially between the top wall 30 and a bottom edge 52 of the exterior wall 46 and each of the slots 50 is aligned with a respective one of the pair of holes 38 in the outer wall 32 of the first box 26. The bottom edge 52 of the exterior wall 46 is aligned with a lower edge 54 of the outer wall 32 of the first box 26 when the second box 40 is in the first position. Furthermore, the bottom edge 52 of the exterior wall 46 is spaced upwardly from the lower edge 54 of the outer wall 32 of the first box 26 when the second box 40 is in the second position. The second box 40 may have a height of approximately 5.0 cm and a width of approximately 5.0 cm.

A pin 56 extends through each of the pair of holes 38 in the outer wall 32 of the first box 26 and each of the pair of slots 50 in the exterior wall 46 of the second box 40 thereby facilitating the second box 40 to slide upwardly and downwardly in the first box 26. A biasing member 58 is provided and the biasing member 58 is positioned between the upper wall 44 of the second box 40 and the top wall 30 of the first box 26. The biasing member 58 biases the second box 40 into the first position and the biasing member 58 is compressed when the second box 40 is urged into the second position.

In use, the water pipe 18 is excavated to expose the clean out cap 16 and the shaft 20 is extended into the hole 14 to facilitate the first box 26 to engage the knob of the first size 28 on the clean out cap 16. In this way the grip 22 can be manipulated to rotate the shaft 20 and remove the clean out cap 16 from the water pipe 18. The second box 40 is urged into the second position when the second box 40 abuts the knob of the first size 28 to facilitate the knob of the first size 28 to extend into the first box 26. Thus, the clean out cap 16 can be removed when the water pipe 18 is too deep to be reached with a wrench or other type of hand-held tool. The second box 40 remains in the first position when the knob of the second size 42 extends into the second box 40. In this way the second box 40 engages the knob of the second size 42 that would otherwise be too small to be engaged by the first box 26.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A clean out cap removal device for facilitating a clean out cap to be removed from a buried water pipe, said device comprising:
a handle having a length of at least 75.0 cm wherein said handle is configured to be extended into a hole to reach a clean out cap on a buried water pipe;
a first box being attached to said handle wherein said first box is configured to engage a knob of a first size on the clean out cap when said handle is extended into the hole thereby facilitating the clean out cap to be removed from the water pipe when said handle is rotated in a first direction and to facilitate the clean out cap to be installed onto the water pipe when said handle is rotated in a second direction; and
a second box being movably positioned within said first box, said second box having dimensions being less than dimensions of said first box wherein said second box is configured to engage a knob of a second size on the clean out cap when said handle is extended into the hole thereby facilitating the clean out cap of the second size to be removed from the water pipe when said handle is rotated in a first direction and to facilitate the clean out cap to be installed onto the water pipe when said handle is rotated in a second direction, said second box being biased into a first position having said second box being positioned to engage the knob of the second size, said second box being urgeable into a second position when said second box abuts the knob of the first size to facilitate said first box to engage the knob of the first size.

2. The device according to claim 1, wherein:
said handle includes a shaft and a grip being transversely oriented on an upper end of said shaft wherein said grip is configured to be gripped by a user having said shaft extending downwardly into the hole; and
said first box has a top wall and an outer wall extending downwardly from said top wall, a bottom end of said shaft being attached to said top wall at a point being centrally located on said top wall.

3. The device according to claim 1, wherein:
said first box has a top wall and an outer wall extending downwardly from said top wall, said outer wall having a plurality of perpendicularly oriented sides such that said first box has a rectangular shape wherein said first box is configured to conform to the shape of the knob on the clean out cap;
said first box has a pair of holes each extending through a respective one of said plurality of perpendicularly oriented sides of said outer wall; and
said pair of holes is positioned on opposite sides of said outer wall with respect to each other.

4. The device according to claim 3, wherein:
said second box has an upper wall and an exterior wall extending downwardly from said upper wall, said exterior wall having a plurality of perpendicularly oriented sides such that said second box has a rectangular shape wherein said second box is configured to conform to the shape of the knob of the second size;
said second box has a pair of slots each extending through said exterior wall;
said pair of slots being positioned on opposite sides of said exterior wall with respect to each other;
each of said pair of slots is elongated to extend substantially between said top wall and a bottom edge of said exterior wall; and
each of said slots is aligned with a respective one of said pair of holes in said outer wall of said first box.

5. The device according to claim 4, wherein:
said bottom edge of said exterior wall is aligned with a lower edge of said outer wall of said first box when said second box is in said first position; and
said bottom edge of said exterior wall is spaced upwardly from said lower edge of said outer wall of said first box when said second box is in said second position.

6. The device according to claim 4, further comprising a pin extending through each of said pair of holes in said outer wall of said first box and each of said pair of slots in said exterior wall of said second box thereby facilitating said second box to slide upwardly and downwardly in said first box.

7. The device according to claim 4, further comprising a biasing member being positioned between said upper wall of said second box and said top wall of said first box, said biasing member biasing said second box into said first position, said biasing member being compressed when said second box is urged into said second position.

8. A clean out cap removal device for facilitating a clean out cap to be removed from a buried water pipe, said device comprising:
a handle having a length of at least 75.0 cm wherein said handle is configured to be extended into a hole to reach a clean out cap on a buried water pipe, said handle including a shaft and a grip being transversely oriented on an upper end of said shaft wherein said grip is configured to be gripped by a user having said shaft extending downwardly into the hole;
a first box being attached to said handle wherein said first box is configured to engage a knob of a first size on the clean out cap when said handle is extended into the hole thereby facilitating the clean out cap to be removed from the water pipe when said handle is rotated in a first direction and to facilitate the clean out cap to be installed onto the water pipe when said handle is rotated in a second direction, said first box having a top wall and an outer wall extending downwardly from said top wall, a bottom end of said shaft being attached to said top wall at a point being centrally located on said top wall, said outer wall having a plurality of perpendicularly oriented sides such that said first box has a rectangular shape wherein said first box is configured to conform to the shape of the knob on the clean out cap, said first box having a pair of holes each extending through a respective one of said plurality of perpendicularly oriented sides of said outer wall, said pair of holes being positioned on opposite sides of said outer wall with respect to each other;
a second box being movably positioned within said first box, said second box having dimensions being less than dimensions of said first box wherein said second box is configured to engage a knob of a second size on the clean out cap when said handle is extended into the hole thereby facilitating the clean out cap to be removed from the water pipe when said handle is rotated in a first direction and to facilitate the clean out cap to be installed onto the water pipe when said handle is rotated in a second direction, said second box being biased into a first position having said second box being positioned to engage the knob of the second size, said second box being urgeable into a second position when said second box abuts the knob of the first size to facilitate said first box to engage the knob of the first size, said second box having an upper wall and an exterior wall extending downwardly from said upper wall, said exterior wall having a plurality of perpendicularly oriented sides such that said second box has a rectangular shape wherein said second box is configured to conform to the shape of the knob of the second size, said second box having a pair of slots each extending through said exterior wall, said pair of slots being positioned on opposite sides of said exterior wall with respect to each other, each of said pair of slots being elongated to extend substantially between said top wall and a bottom edge of said exterior wall, each of said slots being aligned with a respective one of said pair of holes in said outer wall of said first box, said bottom edge of said exterior wall being aligned with a lower edge of said outer wall of said first box when said second box is in said first position, said bottom edge of said exterior wall being spaced upwardly from said lower edge of said outer wall of said first box when said second box is in said second position;
a pin extending through each of said pair of holes in said outer wall of said first box and each of said pair of slots in said exterior wall of said second box thereby facilitating said second box to slide upwardly and downwardly in said first box; and
a biasing member being positioned between said upper wall of said second box and said top wall of said first box, said biasing member biasing said second box into said first position, said biasing member being compressed when said second box is urged into said second position.
